(19) United States
(12) Patent Application Publication
(10) Pub. No.: US 2007/0279746 A1
(43) Pub. Date: Dec. 6, 2007

(54) Head-height holographic projection device for motor vehicle

(76) Inventors: Laurent Tupinier, Reichstett (FR); Arnaud Ballu, St. Lyphard (FR)

Correspondence Address: DELPHI TECHNOLOGIES, INC., M/C 480-410-202, PO BOX 5052, TROY, MI, 48007, US

(21) Appl. No.: 11/805,668

(22) Filed: May 24, 2007

(30) Foreign Application Priority Data
Jun. 1, 2006 (EP) 06290909.8

(51) Int. Cl. G02B 5/18

(52) U.S. Cl. 359/576

(57) ABSTRACT

Head-height projection device for motor vehicles, including a projection unit which projects towards a holographic mirror images relating to operational data of the vehicle or driving data, the said holographic mirror consisting of an optical diffraction grating arranged in the axis of vision of the driver.

### TECHNICAL FIELD

The present invention relates to a head-height holographic projection device for a motor vehicle, i.e. an optical system allowing the driver to view data relating to the driving of his vehicle or its operation via a holographic mirror positioned within his field of view.

### BACKGROUND OF THE INVENTION

The device of the invention consequently includes a projection unit and an assembly of diffractive elements acting as a mirror permitting projection of the data onto a pre-defined location.

Existing systems place the fusion optics under the dashboard and use a semi-reflective film incorporated in the windscreen to project the image to the front of the vehicle. These fusion optics are generally complex, as they must be suited to the particular geometry of the windscreen, i.e. in particular be conformed to match the curvature of the latter. The system, once installed, is in any case not easy to modify in that it is an integral part of the vehicle, and it requires very exact focusing which can only be performed in the assembly factory and not at the distributor's premises, which makes it difficult to maintain.

In existing configurations, the projection unit is generally situated under the dashboard so as to be able to project the image in front of and at the bottom of the windscreen. Known systems allow positioning of the data approximately 3 metres in front of the driver of the vehicle, which consequently gives the impression of seeing the data displayed outside the vehicle, in a space above the bonnet or the road.

### SUMMARY OF THE INVENTION

The invention moves away from traditional approaches to head-height viewing systems, and proposes a much less expensive system than existing devices and considerably more simple to implement, both as regards installation and possible repairs, in initial assembly or upfitting.

To this end, the head-height holographic projection device specific to the invention is characterised principally by the fact that the, projection unit projects towards a holographic mirror images relating to vehicle operational data or driving data, the said holographic mirror consisting of at least one optical diffraction grating arranged in the axis of vision of the driver.

Consequently, under all circumstances, the holographic mirror should be placed within the range of view and positioned in the direction of view of the driver when, in his natural driving position, he is looking through the windscreen.

In fact, and preferably, this holographic mirror is formed by embossing or injection on transparent plastics. It can also, when necessary, be formed of dichromatic gelatin deposited in a layer on a transparent substrate. In this case, the layer of gelatin can have a thickness of between 5 μm and 15 μm, for example.

These technologies permit the virtual holographic projection of instantaneous data, and they are therefore suitable for viewing driving or operating data of the vehicle, which are by their nature non-permanent.

One of the main advantages of the invention resides in the fact that the holographic mirror can be arranged on a flat support, which makes it considerably easier to mount and simplifies the whole of the device employed.

In accordance with one advantageous possibility, in particular in terms of ease of use, the holographic mirror can in particular be located on a transparent sun-visor screen.

This arrangement has multiple advantages. Firstly, such a sun-visor is a flat transparent surface and it is consequently much easier to manage placement of the mirror. Next, this means that such a system can be installed with no particular obstacle by upfitting, i.e. on a car which was not originally fitted with it. Lastly, maintenance or replacement operations are facilitated by the fact that the sun-visor can itself very easily be removed.

Preferably, the sun-visor can integrate an electrochromic film the tint of which darkens when ambient luminosity increases.

This characteristic adds to the user comfort offered by the invention, since whatever the exterior luminosity conditions, for example due to sun, may be, the data displayed via the holographic mirror remain perfectly visible to the driver.

In accordance with a possible geometry, the holographic mirror is rectangular with dimensions of the order of 55 to 65 mm by 55 to 65 mm which appears suitable for use associated with a sun-visor, in a vehicle passenger space.

In accordance with one possibility, the projection unit used by the invention includes a laser diode or a high-power LED emitting a beam directed towards an objective for expansion of the beam, and then towards a polarizing component, an LCD screen connected to a computer processing the data to be projected and forming a source image, a focusing lens, a filter diaphragm and an opalized diffusion lens.

In practice, the holographic mirror reflects the light from the final image formed on the diffusion lens. The driver has the impression that the image is formed behind the holographic mirror, in his field of vision. Several colours can, of course, be imagined, but the “holographic mirror” cannot absorb the combination of three colours, and only management of monochrome data per zone of the said mirror can therefore be considered.

Preferably, the lenses and the filter diaphragm are made as flat diffractive optical elements.

Of course, such a possibility considerably simplifies the design of the projection unit. This is the more advantageous as for example within the context of its association with a holographic mirror located on a sun-visor, in the invention the projection unit is arranged in the vicinity of the interior light of the vehicle and its miniaturisation is then obviously considered as a preponderant advantage.

### BRIEF DESCRIPTION OF THE DRAWINGS

The invention will now be described in more detail, with reference to the figures, in which:

FIG. 1 shows a perspective view of a dashboard with a sun-visor over it and a portion of the ceiling of the vehicle provided with a system in accordance with the invention;

FIG. 2 shows diagrammatically the appearance and relative dimensions of a sun-visor provided with a holographic mirror permitting implementation of the invention; and

FIG. 3 shows a simplified optical diagram of a projector which can be used within the framework of the invention.

### DESCRIPTION OF THE PREFERRED EMBODIMENT

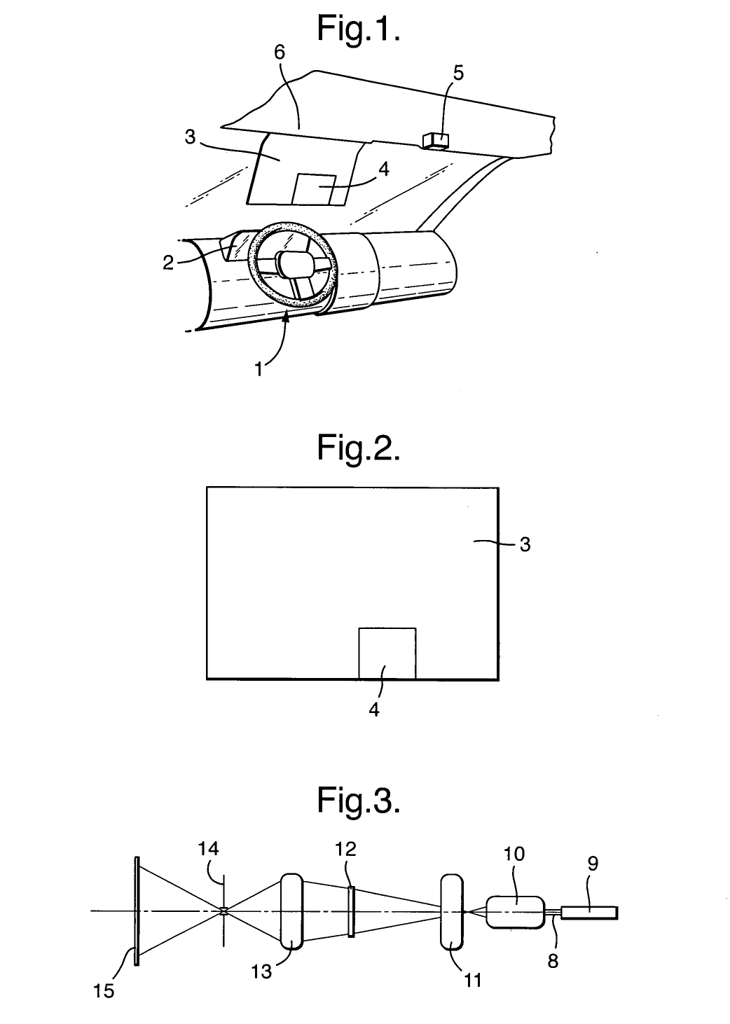

With reference to FIG. 1, the dashboard (1) of the vehicle including the steering wheel (2) is situated under a sun-visor (3) including in its lower part a holographic mirror (4). A projector (5) is arranged in the vicinity of the interior light (not shown). The sun-visor (3) or the support of the holographic mirror includes guiding means (6) permitting deployment/retraction when required. The holographic mirror (4) permits projection of different data of the type of speed, oil level, existence of a vehicle in a blind spot, etc., according to the choice of the vehicle manufacturer.

The sun-visor (3), which can also be seen in FIG. 2, is for example made of plastics provided with an electrochromic film, so that construction of the holographic element (4) is much simpler than in configurations of the prior art. The system is monocular and the holographic mirror must consequently be positioned in front of the eyes of the driver, in his axis of vision. As already indicated, the hologram functioning in the manner of a mirror, it must consequently be not only within the field of view of the driver, but the latter must in addition look at it to have visual access to the projected data. This must therefore be possible while the driver is in his natural driving position.

In accordance with one possibility, the holographic layer, of the order of 10 microns, is formed on a substrate of plastics or the like having a thickness for example close to 3 mm.

Still on a dimensional plane, the holographic mirror (4) in accordance with a configuration suited to the volume of the passenger space and to the position of the driver, can be a square of the order of 60 mm side integrated for example in a sun-visor (3) the dimensions of which are approximately 300 mm×200 mm. Any other support can nevertheless be used provided that its location can provide the function of the holographic mirror of the invention.

The precise location of the holographic mirror (4) is not necessarily that shown in FIGS. 1 and 2. The positioning in fact depends on the relative dimensions of the sun-visor (3) and of the mirror (4) on one hand, on the internal lay-out of the vehicle, on the possibilities of adjusting the position of the sun-visor (3) and of the driving seat, etc.

The projection unit is shown diagrammatically in FIG. 3. It is composed of a certain number of optical components which are intended to send a source image to a holographic mirror, which has the function of reflecting the light from this image, as it is formed at the output of the projection unit. More precisely, a laser diode (9) emits a laser beam (8) towards an objective (10), which creates expansion of the beam (8). This diode (9) can be replaced by a high-power LED.

A polarizing lens (11) then polarises the light which it emits towards an LCD screen (12). This screen is connected to the on-board computer of the vehicle, which sends it the data intended to be projected onto the holographic mirror (4).

The source image appearing on the LCD screen (12) is then focused, by means of a lens (13), towards a diaphragm (14) with an orifice centred on the optical axis. The image is consequently filtered by this diaphragm (14), before being projected onto an opalized diffusing lens (15).

The use of a system based on a projection unit located at the interior light, with a holographic mirror situated on a sun-visor, proves particularly advantageous since this in fact allows addition of such systems to be considered to vehicles which were not fitted with them on construction.

The hologram functioning as a mirror, requiring the driver to look in its direction and consequently to have his regard fixed on the environment of the vehicle, is advantageous in that it increases driving safety.

Of course, the present invention is not limited to the example illustrated in the preceding figures, which are consequently not limiting to it. Details of shape, configuration, or choice of materials, etc., can be modified without thereby departing from the scope of the present invention.

1. A head-height holographic projection device for motor vehicles, comprising a projection unit which projects towards a holographic mirror images relating to operational data of the vehicle or driving data, the said holographic mirror consisting of an optical diffraction grating arranged in the axis of vision of the driver.

2. The head-height holographic projection device of claim 1, wherein the holographic mirror is formed by embossing or injection on transparent plastics.

3. The head-height holographic projection device of claim 1, wherein the holographic mirror is made of dichromatic gelatin deposited in a layer on a transparent substrate.

4. The head-height holographic projection device of claim 3, wherein the gelatin layer has a thickness of between 5 μm and 15 μm.

5. The head-height holographic projection device of claim 1, wherein the holographic mirror is placed on a flat support.

6. The head-height holographic projection device of claim 5, wherein the holographic mirror is placed on a transparent sun-visor screen.

7. The head-height holographic projection device of claim 6, wherein the sun-visor includes an electrochromic film the tint of which darkens when ambient luminosity increases.

8. The head-height holographic projection device of claim 6, wherein the holographic mirror is rectangular with dimensions of the order of 55 to 65 mm×55 to 65 mm.

9. The head-height holographic projection device of claim 1, wherein the projection unit includes a laser diode or a high-power LED, emitting a beam directed towards an objective for expansion of the beam and then towards a polarizing component, an LCD screen connected to a computer processing the data to be projected, and forming a source image, a focusing lens, a filter diaphragm and an opalized diffusion lens.

10. The head-height holographic projection device of claim 9, wherein the lenses and the filter diaphragm are formed as flat diffractive optical elements.

11. The head-height holographic projection device of claim 6, wherein the projection unit is arranged in the vicinity of the interior light of the vehicle.
